(19) United States
(12) Patent Application Publication
(10) Pub. No.: US 2019/0253686 A1
(43) Pub. Date: Aug. 15, 2019

(54) SYSTEMS AND METHODS FOR GENERATING AUDIO-ENHANCED IMAGES

(71) Applicant: GoPro, Inc., San Mateo, CA (US)

(72) Inventor: Jessica Bonner, San Francisco, CA (US)

(21) Appl. No.: 15/717,436

(22) Filed: Sep. 27, 2017

(51) Int. Cl. H04N 9/802; G11B 27/031; H04N 5/232; H04S 7/00

(52) U.S. Cl. CPC H04N 9/802; G11B 27/031; H04S 2420/11; H04S 7/30; H04N 5/23238

(57) ABSTRACT

Image information may define spherical image content. Audio information may define audio content having a duration. The audio content may be captured before, during, and/or after capture of the spherical image content. Image-audio information defining audio-enhanced spherical image content may be generated. The image-audio information may include the image information and the audio information within a structure such that a viewing of the audio-enhanced spherical image content includes a presentation of the visual content on a display with a playback of the audio content. The presentation of the visual content may enable movement of a viewing window during the playback of the audio content. The viewing window may define extents of the visual content viewable from a point of view and presented on the display. The image-audio information may be stored in one or more storage media.

### FIELD

This disclosure relates to generating audio-enhanced images using spherical image content and audio content.

### BACKGROUND

An image may include greater visual capture of one or more scenes/objects/activities than may be viewed at a time (e.g., over-capture). Audio of the scenes/objects/activities may enhance consumption experience for the image

### SUMMARY

This disclosure relates to generating audio-enhanced images. Image information, audio information and/or other information may be obtained. The image information may define spherical image content. The spherical image content may define visual content viewable from a point of view. The audio information may define audio content. The audio content may have a duration. The audio content may be captured before, during, and/or after capture of the spherical image content. Image-audio information defining audio-enhanced spherical image content may be generated. The image-audio information may include the image information, the audio information, and/or other information within a structure such that a viewing of the audio-enhanced spherical image content includes a presentation of the visual content on a display with a playback of the audio content and/or other content. The presentation of the visual content may enable movement of a viewing window during the playback of the audio content. The viewing window may define extents of the visual content viewable from the point of view and presented on the display. The image-audio information may be stored in one or more storage media.

A system that generates audio-enhanced images may include one or more of display, electronic storage, processor, and/or other components. The display may be configured to present image content and/or other information. In some implementations, the display may include a touchscreen display. The touchscreen display may be configured to generate touchscreen output signals indicating locations on the touchscreen display of user engagement with the touchscreen display.

The electronic storage may store image information defining image content, audio information defining audio content, and/or other information. Image content may refer to media content that may be consumed as one or more images. Image content may include one or more images stored in one or more formats/containers, and/or other image content. The image content may define viewable visual content. The image content may include spherical image content and/or other image content. Spherical image content may define visual content viewable from a point of view. In some implementations, spherical image content may include one or more spherical images and/or other images. In some implementations, spherical image content may be consumed as virtual reality content.

Audio content may refer to media content that may be consumed as one or more sounds. Audio content may include one or more sounds stored in one or more formats/containers, and/or other audio content. Audio content may have a duration. Audio content may be captured before, during, and/or after capture of the image content.

In some implementations, the image content may be captured by an image capture device and the audio content may be captured by an audio capture device of the image capture device. In some implementations, the image content may be captured by an image capture device and the audio content may be captured by an audio capture device separate from the image capture device.

In some implementations, the spherical image content may correspond to a midpoint of the duration of the audio content. In some implementations, the spherical image content may correspond to a non-midpoint of the duration of the audio content.

In some implementations, the audio content may include one or more spatial sounds. The audio information may characterize one or more directions of the spatial sound(s) within the audio content.

The processor(s) may be configured by machine-readable instructions. Executing the machine-readable instructions may cause the processor(s) to facilitate generating audio-enhanced images. The machine-readable instructions may include one or more computer program components. The computer program components may include one or more of an image information component, an audio information component, an image-audio information component, a storage component, and/or other computer program components.

The image information component may be configured to obtain image information defining one or more image content (e.g., spherical image content) and/or other information. The image information component may obtain image information from one or more storage locations. The image information component may be configured to obtain image information during acquisition of the image content and/or after acquisition of the image content by one or more image sensors.

The audio information component may be configured to obtain audio information defining one or more audio content and/or other information. The audio information component may obtain audio information from one or more storage locations. The audio information component may be configured to obtain audio information during acquisition of the audio content and/or after acquisition of the audio content by one or more sound sensors.

In some implementations, the image content may be determined prior to a determination of the audio content. In some implementations, the audio content may be determined prior to a determination of the image content. In some implementations, the audio content may be determined based on one or more of user selection, audio analysis, highlight events, and/or other information.

The image-audio information component may be configured to generate image-audio information and/or other information. The image-audio information may define audio-enhanced spherical image content. The image-audio information may include the image information, the audio information, and/or other information within a structure such that a consumption of the audio-enhanced spherical image content includes a presentation of the visual content on a display with a playback of the audio content.

The presentation of the visual content may enable movement of a viewing window during the playback of the audio content. The viewing window may define extents of the visual content viewable from the point of view and presented on the display. In some implementations, the playback of the audio content may change based on the movement of the viewing window during the playback of the audio content, the one or more directions of the spatial sound(s) within the audio content, and/or other information.

The storage component may be configured to effectuate storage of the image-audio information and/or other information in one or more storage media. The storage component may effectuate storage of the image-audio information in one or more storage locations including the image information and/or the audio information and/or other storage locations.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system that generates audio-enhanced images.

FIG. 2 illustrates a method for generating audio-enhanced images.

FIG. 3 illustrates an example spherical image content.

FIGS. 4A-4B illustrate example extents of spherical image content.

FIG. 5 illustrates example correspondence between image moments and audio durations.

FIG. 6 illustrates example sound sources with respect to image content.

FIGS. 7-8 illustrate example processes for selecting audio content duration and spherical image content.

FIG. 9 illustrates example viewing directions for spherical image content.

FIG. 10 illustrates an example mobile device for consuming audio-enhanced images.

### DETAILED DESCRIPTION

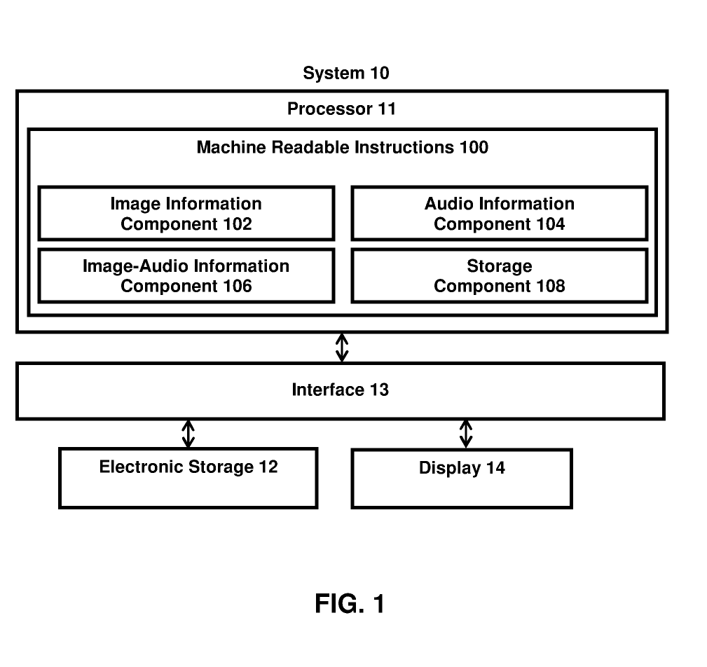

FIG. 1 illustrates a system 10 for generating audio-enhanced images. The system 10 may include one or more of a processor 11, an electronic storage 12, an interface 13 (e.g., bus, wireless interface), a display 14, and/or other components. Image information, audio information and/or other information may be obtained by the processor 11. The image information may define spherical image content. The spherical image content may define visual content viewable from a point of view. The audio information may define audio content. The audio content may have a duration. The audio content may be captured before, during, and/or after capture of the spherical image content. Image-audio information defining audio-enhanced spherical image content may be generated by the processor 11. The image-audio information may include the image information, the audio information, and/or other information within a structure such that a viewing of the audio-enhanced spherical image content includes a presentation of the visual content on a display with a playback of the audio content and/or other content. The presentation of the visual content may enable movement of a viewing window during the playback of the audio content. The viewing window may define extents of the visual content viewable from the point of view and presented on the display. The image-audio information may be stored in one or more storage media.

The electronic storage 12 may be configured to include electronic storage medium that electronically stores information. The electronic storage 12 may store software algorithms, information determined by the processor 11, information received remotely, and/or other information that enables the system 10 to function properly. For example, the electronic storage 12 may store information relating to image information, image content (e.g., spherical image content), audio information, audio content, image-audio information, audio-enhanced image content (e.g., audio-enhanced spherical image content), and/or other information.

For example, the electronic storage 12 may store image information defining one or more image content, audio information defining audio content, and/or other information. Image content may refer to media content that may be consumed as one or more images. Image content may include one or more images stored in one or more formats/containers, and/or other image content. A format may refer to one or more ways in which the information defining image content is arranged/laid out (e.g., file format). A container may refer to one or more ways in which information defining image content is arranged/laid out in association with other information (e.g., wrapper format). An image may include an image/image portion captured by an image capture device, multiple images/image portions captured by a image capture device, and/or multiple images/image portions captured by separate image capture devices. An image may include multiple images/image portions captured at the same time and/or multiple images/image portions captured at different times. An image may include an image/image portion processed by an image application, multiple images/image portions processed by an image application and/or multiple images/image portions processed by separate image applications.

Image content may define viewable visual content. In some implementations, image content may include one or more of spherical image content, virtual reality content, and/or image video content. Spherical image content and/or virtual reality content may define visual content viewable from a point of view.

Spherical image content may refer to an image capture of multiple views from a location. Spherical image content may include a full spherical image capture (360 degrees of capture, including opposite poles) or a partial spherical image capture (less than 360 degrees of capture). In some implementations, spherical image content may include one or more spherical images and/or other images. In some implementations, spherical image content may be consumed as virtual reality content.

Spherical image content may be captured through the use of one or more cameras/image sensors to capture image(s) from a location. For example, multiple images captured by multiple image sensors may be stitched together to form the spherical image content. The field of view of image sensor(s) may be moved/rotated (e.g., via movement/rotation of optical element(s), such as lens, of the image sensor(s)) to capture multiple images form a location, which may be stitched together to form the spherical video content.

Virtual reality content may refer to content (e.g., spherical image content) that may be consumed via virtual reality experience. Virtual reality content may associate different directions within the virtual reality content with different viewing directions, and a user may view a particular directions within the virtual reality content by looking in a particular direction. For example, a user may use a virtual reality headset to change the user's direction of view. The user's direction of view may correspond to a particular direction of view within the virtual reality content. For example, a forward looking direction of view for a user may correspond to a forward direction of view within the virtual reality content.

Spherical image content and/or virtual reality content may have been captured at one or more locations. For example, spherical image content and/or virtual reality content may have been captured from a stationary position (e.g., a seat in a stadium). Spherical image content and/or virtual reality content may have been captured from a moving position (e.g., a moving bike). Spherical image content and/or virtual reality content may include image capture from a path taken by the capturing device(s) in the moving position. For example, spherical image content and/or virtual reality content may include image capture from a person walking around in a music festival.

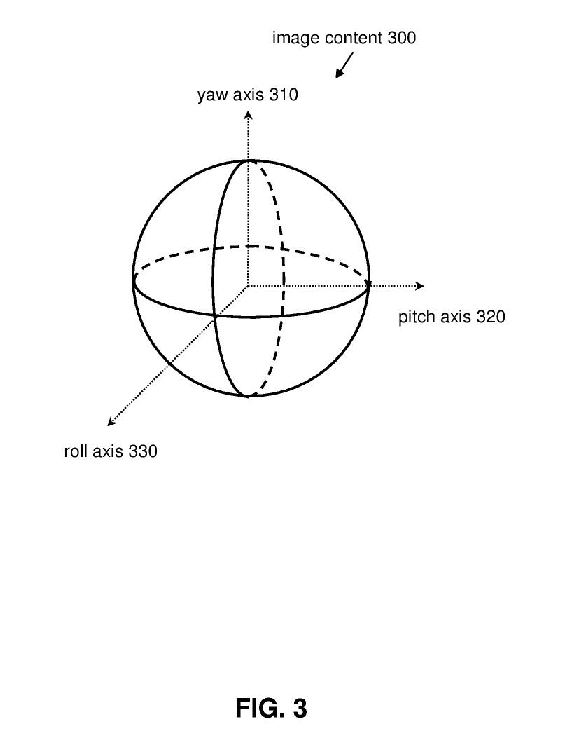

FIG. 3 illustrates an example image content 300 defined by image information. The image content 300 may include spherical image content. In some implementations, spherical image content may be stored with a 5.2K resolution. Using a 5.2K spherical image content may enable viewing windows for the spherical image content with resolution close to 1080p. In some implementations, spherical image content may include 12-bit image(s). FIG. 3 illustrates example rotational axes for the image content 300. Rotational axes for the image content 300 may include a yaw axis 310, a pitch axis 320, a roll axis 330, and/or other axes. Rotations about one or more of the yaw axis 310, the pitch axis 320, the roll axis 330, and/or other axes may define viewing directions/viewing window for the image content 300.

For example, a 0-degree rotation of the image content 300 around the yaw axis 310 may correspond to a front viewing direction. A 90-degree rotation of the image content 300 around the yaw axis 310 may correspond to a right viewing direction. A 180-degree rotation of the image content 300 around the yaw axis 310 may correspond to a back viewing direction. A −90-degree rotation of the image content 300 around the yaw axis 310 may correspond to a left viewing direction.

A 0-degree rotation of the image content 300 around the pitch axis 320 may correspond to a viewing direction that is level with respect to horizon. A 45-degree rotation of the image content 300 around the pitch axis 320 may correspond to a viewing direction that is pitched up with respect to horizon by 45-degrees. A 90 degree rotation of the image content 300 around the pitch axis 320 may correspond to a viewing direction that is pitched up with respect to horizon by 90-degrees (looking up). A −45-degree rotation of the image content 300 around the pitch axis 320 may correspond to a viewing direction that is pitched down with respect to horizon by 45-degrees. A −90 degree rotation of the image content 300 around the pitch axis 320 may correspond to a viewing direction that is pitched down with respect to horizon by 90-degrees (looking down).

A 0-degree rotation of the image content 300 around the roll axis 330 may correspond to a viewing direction that is upright. A 90 degree rotation of the image content 300 around the roll axis 330 may correspond to a viewing direction that is rotated to the right by 90 degrees. A −90-degree rotation of the image content 300 around the roll axis 330 may correspond to a viewing direction that is rotated to the left by 90-degrees. Other rotations and viewing directions are contemplated.

A viewing window may define extents of the visual content viewable on a display (e.g., the display 14). For spherical image content, a viewing window may define extents of the visual content viewable from the point of view. A viewing window may be characterized by a viewing direction, a viewing size (e.g., zoom), and/or other information. A viewing direction may define a direction of view for image content. For example, for spherical image content, a viewing direction may define a direction of view from the point of view from which the visual content is defined. For example, a viewing direction of a 0-degree rotation of the image content around a yaw axis (e.g., the yaw axis 310) and a 0-degree rotation of the image content around a pitch axis (e.g., the pitch axis 320) may correspond to a front viewing direction (the viewing window is directed to a forward portion of the visual content captured within the spherical image content). A viewing window for spherical image content may define extents of the visual content viewable from the point of view and presented on the display (e.g., the display 14).

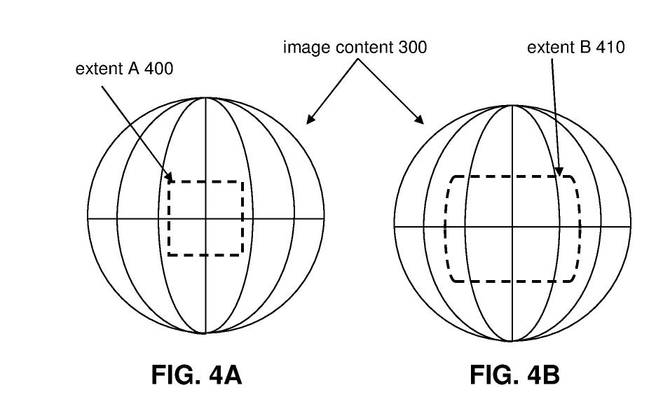

A viewing size may define a size (e.g., zoom) of viewable extents of visual content within the image content. For example, FIGS. 4A-4B illustrate examples of extents for the image content 300. In FIG. 4A, the size of the viewable extent of the image content 300 may correspond to the size of extent A 400. In FIG. 4B, the size of viewable extent of the image content 300 may correspond to the size of extent B 410. Viewable extent of the image content 300 in FIG. 4A may be smaller than viewable extent of the image content 300 in FIG. 4B. In some implementations, a viewing size may define different shapes of extents. For example, a viewing window may be shaped as a rectangle, a triangle, a circle, and/or other shapes. In some implementations, a viewing size may change based on a rotation of viewing. For example, a viewing size shaped as a rectangle may change the orientation of the rectangle based on whether a view of the image content includes a landscape view or a portrait view. Other rotations of a viewing window are contemplated.

Audio content may refer to media content that may be consumed as one or more sounds. Audio content may include one or more sounds captured by one or more sound sensor (e.g., microphone). The sound sensor may receive and convert sounds into sound output signals. The sound output signals may convey sound information and/or other information. The sound information may define audio content in one or more formats, such as WAV, MP3, MP4, RAW.

In some implementations, sound content may be captured by one or more sound sensors included within an image capture device (e.g., spherical image capture device that captured spherical image content). That is, image content may be captured by an image capture device and audio content may be captured by an audio capture device of the image capture device. In some implementations, sound content may be captured by one or more sound sensors separate from the image capture device. That is, image content may be captured by an image capture device and audio content may be captured by an audio capture device separate from the image capture device. In some implementations, sound content may be captured by one or more sound sensors coupled to the image capture device/one or more components of the image capture device.

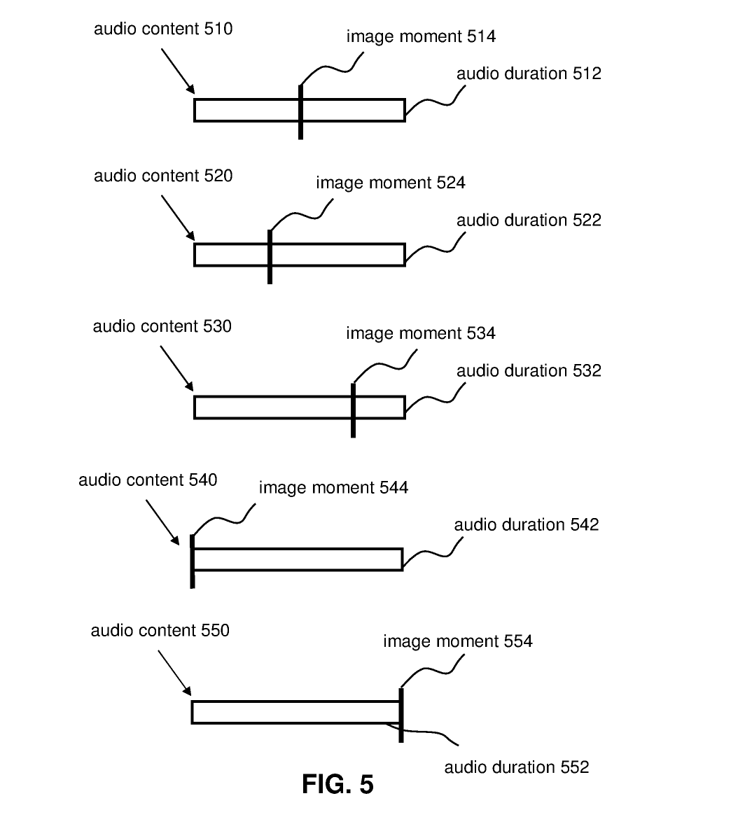

Audio content may have a duration. Audio content may be captured before, during, and/or after capture of the image content. The duration of the audio content may be longer than the duration of the image content. For example, spherical image content may correspond to a midpoint or a non-midpoint of the duration of the audio content. For example, FIG. 5 illustrates example correspondence between image moments 514, 524, 534, 544, 554 and audio durations 512, 522, 532, 542, 552. Audio durations 512, 522, 532, 542, 552 may correspond to time lengths (e.g., playback time durations, captured time durations) of audio content 510, 520, 530, 540, 550. Image moments 514, 524, 534, 544, 554 may indicate moments (e.g., a point in time, a duration of time) during which image content may have been captured.

For example, with respect to the audio content 510, the image content may have been captured at the center of the audio duration 512 (e.g., the audio content 510 includes 2.5 seconds of audio before and after the image content capture). With respect to the audio content 520, the image content may have been captured before the center of the audio duration 522. With respect to the audio content 530, the image content may have been captured after the center of the audio duration 532. With respect to the audio content 540, the image content may have been captured at the beginning of the audio duration 542. With respect to the audio content 550, the image content may have been captured at the end of the audio duration 552. Other correspondence between image moments and audio durations are contemplated.

In some implementations, multiple image content may be captured for audio content. For example, for audio content, time lapse images may be captured. For such image content/audio content, multiple image moments may correspond to different portions of the audio duration.

In some implementations, the audio content may include one or more spatial sounds. Spatial sounds may refer to sounds (e.g., planar 360-sound) within audio content in which the direction of the sounds (e.g., direction from/in which the sound is travelling, spatial relativity of the sound origination to the sound sensor) has been recorded within the audio information (e.g., metadata for audio content). The audio information may characterize one or more directions of the spatial sound(s) within the audio content. The spatial information relating to sounds within the audio content may be stored using spatial-sound techniques (e.g., surround sound, absences).

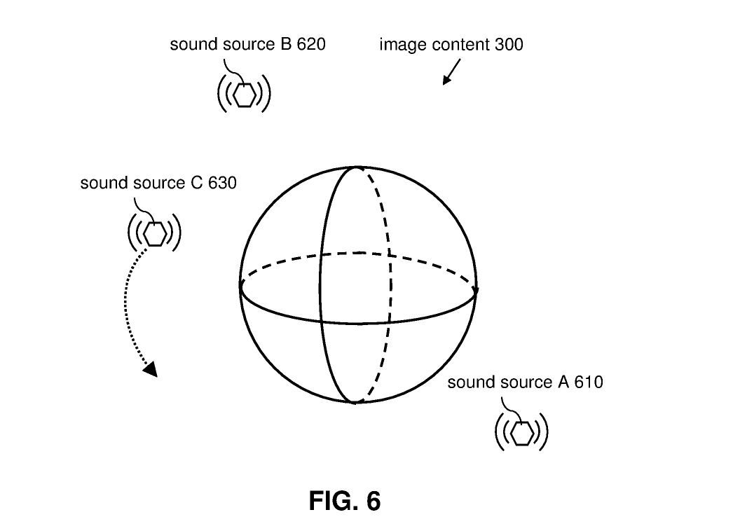

FIG. 6 illustrates example sound sources 610, 620, 630 with respect to the image content 300. The sound source A 610 may be located to the front, left, and below the capture of the image content 300. The sound source B 620 may be located to the rear, right, and above the capture of the image content 300. The sound source C 630 may be located to the right of the capture of the image content 300, and may move from the rear to the front of the capture of the image content 300. Audio content captured based on sounds traveling from the sound sources 610, 620, 630 may include spatial sounds with their spatial relativity recorded within the audio information. Such spatial relativity of the spatial sounds to the image content 300 may allow the spatial sounds to be played differently based on which visual extent of the image content 300 is being viewed/presented on a display. For example, a user's viewing of the image content in the front viewing direction may include the spatial sound from the sound source A 610 being played to simulate the sound coming from the front, left, and below the user, the spatial sound from the sound source B 620 being played to simulate the sound coming from the rear, right, and above the user, and the spatial sound from the sound source C 630 being played to simulate the sound coming from the right and rear of the user to the right and front of the user.

The display 14 may be configured to present image content and/or other information. In some implementations, the display 14 may include a touchscreen display configured to receive user input via user engagement with the touchscreen display. For example, the display 14 may include a touchscreen display of a mobile device (e.g., camera, smartphone, tablet, laptop). The touchscreen display may be configured to generate touchscreen output signals indicating a location on the touchscreen display of user engagement with the touchscreen display.

Referring to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine readable instructions 100 to facilitate generating audio-enhanced images. The machine readable instructions 100 may include one or more computer program components. The machine readable instructions 100 may include one or more of an image information component 102, an audio information component 104, an image-audio information component 106, a storage component 108, and/or other computer program components.

The image information component 102 may be configured to obtain image information defining one or more image content (e.g., spherical image content) and/or other information. Obtaining image information may include one or more of accessing, acquiring, analyzing, determining, examining, loading, locating, opening, receiving, retrieving, reviewing, storing, and/or otherwise obtaining the image information. The image information component 102 may obtain image information from one or more locations. For example, the image information component 102 may obtain image information from a storage location, such as the electronic storage 12, electronic storage of information and/or signals generated by one or more image sensors (not shown in FIG. 1), electronic storage of a device accessible via a network, and/or other locations. The image information component 102 may obtain image information from one or more hardware components (e.g., an image sensor) and/or one or more software components (e.g., software running on a computing device).

The image information component 102 may be configured to obtain image information defining one or more image content during acquisition of the image content and/or after acquisition of the image content by one or more image sensors. For example, the image information component 102 may obtain image information defining an image while the image is being captured by one or more image sensors. The image information component 102 may obtain image information defining an image after the image has been captured and stored in memory (e.g., the electronic storage 12).

The audio information component 104 may be configured to obtain audio information defining one or more audio content (e.g., spatial audio content) and/or other information. Obtaining audio information may include one or more of accessing, acquiring, analyzing, determining, examining, loading, locating, opening, receiving, retrieving, reviewing, storing, and/or otherwise obtaining the audio information. The audio information component 106 may obtain audio information from one or more locations. For example, the audio information component 104 may obtain audio information from a storage location, such as the electronic storage 12, electronic storage of information and/or signals generated by one or more sound sensors (not shown in FIG. 1), electronic storage of a device accessible via a network, and/or other locations. The audio information component 104 may obtain audio information from one or more hardware components (e.g., a sound sensor) and/or one or more software components (e.g., software running on a computing device).

The audio information component 104 may be configured to obtain audio information during acquisition of the audio content and/or after acquisition of the audio content by one or more sound sensors. For example, the audio information component 104 may obtain audio information defining spatial sounds while the sounds are being captured by one or more sound sensors. The audio information component 104 may obtain audio information defining sounds after the sounds have been captured and stored in memory (e.g., the electronic storage 12).

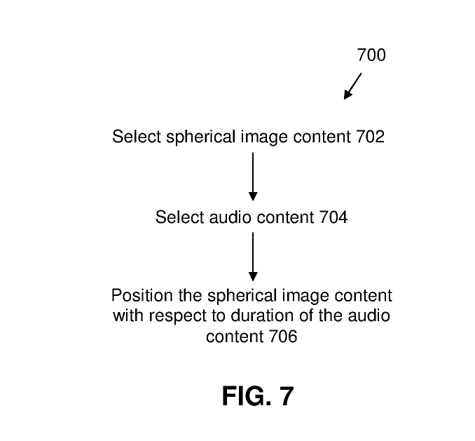

In some implementations, the image content may be determined prior to a determination of the audio content. For example, the image content and the audio content may be determined as shown in a process 700 shown in FIG. 7. In the process 700, a user may have access to one or more spherical image content. The user may select one or more particular spherical image content, such as a particular spherical video frame of spherical video content for inclusion in audio-enhanced image content (Step 702). The user may then select audio content for inclusion in the audio-enhanced image content (Step 704). The selection of the audio content may include selection one or more particular portions of longer audio content (e.g., selection of a portion of audio of audio captured with spherical video content). The user may then position the selected spherical image content with respect to the duration of the audio content (Step 706), such as shown in FIG. 5.

In some implementations, the selection of the audio content may be determined based on user selection (e.g., user-specified duration, user selection of duration options), based on system defaults (e.g., certain amount(s) of audio before and/or after the image moment), based on audio analysis (e.g., audio content determined to include particular sound pattern and/or intensity such that the duration of the sound content does not start after or end before a particular sound), based on highlight events (e.g., audio content determined to include a particular highlight sound captured within longer audio content, audio content determined based on a particular highlight event captured within the selected image content), and/or other information.

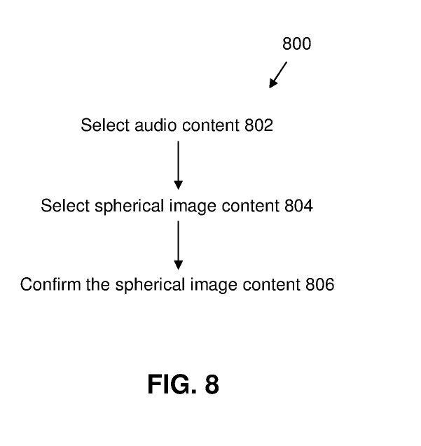

In some implementations, the audio content may be determined prior to a determination of the image content. For example, the image content and the audio content may be determined as shown in a process 800 shown in FIG. 8. In the process 800, a user may select audio content for inclusion in audio-enhanced image content (Step 802). The selection of the audio content may include selection one or more particular portions of longer audio content (e.g., selection of a portion of audio of audio captured with spherical video content). The user may then select the spherical image content for inclusion in the audio-enhanced image content (Step 804). For example, the selected audio content may be played while the spherical video content corresponding to the selected audio content is display, and the user may selects certain spherical video frame(s) of spherical video content (e.g., “capture” video frames within the video content using a virtual camera). The user may then confirm the selected spherical video video(s) for inclusion in the audio-enhanced image content (Step 806). In some implementations, the user may select/confirm a single video frame for inclusion in the audio-enhanced image content. In some implementations, the user may select/confirm multiple video frames for inclusion in the audio-enhanced image content. Such determination of audio content and image content may simulate the user “recording” audio of the video content while taking pictures within the video content.

The image-audio information component 106 may be configured to generate image-audio information and/or other information. The image-audio information may define audio-enhanced spherical image content. The audio-enhanced spherical image content may include one or more spherical images combined with audio content of a particular duration. The image-audio information may include the image information, the audio information, and/or other information within a structure such that a consumption of the audio-enhanced spherical image content includes a presentation of the visual content (from the point of view of the spherical image(s)) on a display with a playback of the audio content. That is, the image-audio information may include the image information (defining image selected for inclusion in the audio-enhanced image content) and the audio information (defining audio selected for inclusion in the audio-enhanced image content) such that the playback of the audio-enhanced image content includes a presentation of the selected image with a playback of the selected audio content.

In some implementations, the image-audio information may define encoded video content. For example, generating the image-audio information may include encoding the selected image with the selected audio content within video content. For example, the selected image may be replicated as video frames, which are packaged with the selected audio content as a video file (e.g., of one or more video formats, such as MP4).

In some implementations, the image-audio information may include one or more files containing descriptions/instructions regarding which image(s) to display during playback of audio content. For example, the image-audio information may be generated as a director track that includes information as to what image(s) and audio content were selected for inclusion in the audio-enhanced image content. The selectin of the image(s) may be stored within an image track of the director track and the selection of the audio content may be stored within an audio track of the director track. The director track may be used to generate the audio-enhanced image content on the fly. For example, image content and/or audio content may be stored on a server and different director tracks defining different images/audio content may be stored on individual mobile devices and/or at the server. A user wishing to view a particular audio-enhanced image content may provide the corresponding director track to the server and/or select the corresponding director track stored at the server. The audio-enhanced image content may be presented based on the director track. In some implementations, image content and/or audio content may be stored on a client device (e.g., mobile device). A user may access different director tracks to view different audio-enhanced image content without encoding and storing separate audio-enhanced image content. Other uses of director tracks are contemplated.

The creation of the audio-enhanced spherical image content may allow a user to consume/experience different visual portions of the image while listening to the audio content. The presentation of the visual content may enable movement of a viewing window during the playback of the audio content. The viewing window may define extents of the visual content viewable from the point of view and presented on the display (e.g., the display 14). The viewing window may be characterized by a viewing direction, a viewing size (e.g., zoom), and/or other information.

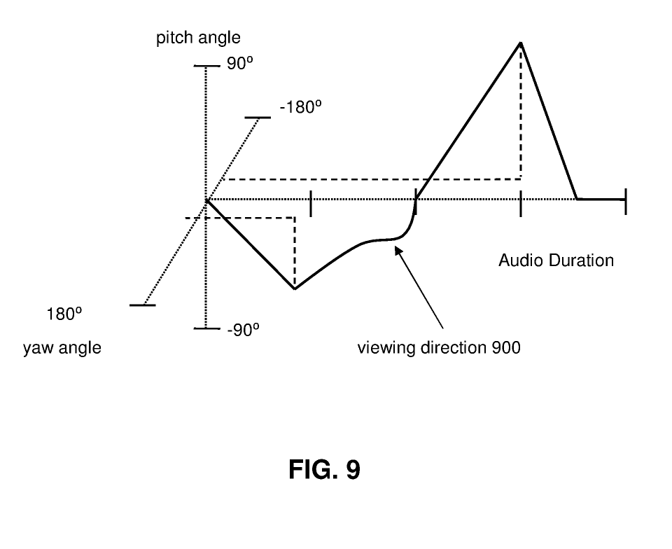

For example, FIG. 9 illustrates example viewing directions 900 selected by a user for viewing audio-enhanced spherical image content as a function of progress through the audio content. The viewing directions 900 may change (e.g., based on user input) as a function of progress through the audio content. For example, at 0% progress mark, the viewing directions 500 may correspond to a zero-degree yaw angle and a zero-degree pitch angle. At 25% progress mark, the viewing directions 500 may correspond to a positive yaw angle and a negative pitch angle. At 50% progress mark, the viewing directions 500 may correspond to a zero-degree yaw angle and a zero-degree pitch angle. At 75% progress mark, the viewing directions 500 may correspond to a negative yaw angle and a positive pitch angle. At 87.5% progress mark, the viewing directions 500 may correspond to a zero-degree yaw angle and a zero-degree pitch angle. Other selections of viewing directions/selections are contemplated.

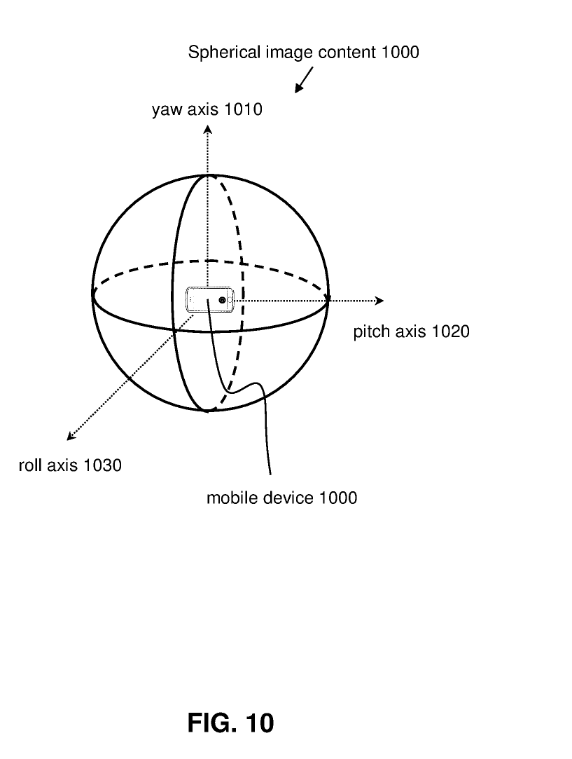

The viewing direction and/or the viewing size of the viewing window for the audio-enhanced spherical image content may be changed based on user input (e.g., received via user interaction with a touchscreen display, rotation of a display, one or more virtual/physical buttons/mouse/keyboards). For example, a user may make pinching/unpinching gestures on a touchscreen display to change the viewing size of the viewing window. A user may change rotation of a mobile device (e.g., mobile device 1000 shown in FIG. 10) to view different visual extents of the audio-enhanced spherical image content. For example, referring to FIG. 10, changes in rotation of the mobile device 100 may results in different views of the spherical image content 1000 (e.g., based on rotations about the yaw axis 1010, the pitch axis 1020, and/or the roll axis 1030). Other types of user input are contemplated.

In some implementations, the playback of the audio content may change based on the movement of the viewing window during the playback of the audio content, the one or more directions of the spatial sound(s) within the audio content, and/or other information. For example, referring to FIG. 6, consumption of an audio-enhanced spherical image content may include a presentation of the visual content defined by the image content 300 along with playback of audio content including recorded sounds from the sound sources 610, 620, 630. The movement of the viewing window may change the playback of recorded sounds from the sound sources 610, 620, 630.

For example, a user consuming the audio-enhanced spherical image content with the viewing window directed to the front of the image content 300 may include the spatial sound from the sound source A 610 being played to simulate the sound coming from the front, left, and below the user, the spatial sound from the sound source B 620 being played to simulate the sound coming from the rear, right, and above the user, and the spatial sound from the sound source C 630 being played to simulate the sound coming from the right and rear of the user to the right and front of the user.

A user consuming the audio-enhanced spherical image content with the viewing window directed to the back of the image content 300 may include the spatial sound from the sound source A 610 being played to simulate the sound coming from the rear, right, and below the user, the spatial sound from the sound source B 620 being played to simulate the sound coming from the front, left, and above the user, and the spatial sound from the sound source C 630 being played to simulate the sound coming from the left and front of the user to the left and rear of the user.

The playback of the audio content may change as the viewing window is moved. For example, the playback of the audio content may change as the viewing window is changed from being directed to the front of the image content 300 to the back of the image content 300. Such playback of the audio content may enable users to experience the spatial characteristics of the audio content while viewing the audio-enhanced image content. For example, the audio-enhanced image content may include a spherical image captured from a location with a person passing on the right side of the spherical image. The spatial sound of the person passing may be included within the audio content. Based on which direction a user is viewing the audio-enhanced image content, the sound of the person passing may be heard from different directions (e.g., a user looking to the right portion of the spherical image may hear the sound of the person passing coming across the viewed image (e.g., right to left, left to right); a user looking to the front portion of the spherical image may hear the sound of the person passing to the left of the viewed image (e.g., front to back, back to front)).

The storage component 108 may be configured to effectuate storage of the image-audio information and/or other information in one or more storage media. In some implementations, the storage component 108 may effectuate storage of the image-audio information in one or more storage locations including the image information and/or the audio information and/or other storage locations. For example, the image information/audio information may have been obtained from the electronic storage 12 and the image-audio information may be stored in the electronic storage 12. In some implementations, the storage component 108 may effectuate storage of the image-audio information in one or more remote storage locations (e.g., storage media located at/accessible through a server). In some implementations, the storage component 108 may effectuate storage of the image-audio information through one or more intermediary devices. For example, the processor 11 may be located within an image capture device without a connection to the storage device (e.g., the image capture device lacks WiFi/cellular connection to the storage device). The storage component 108 may effectuate storage of the image-audio information through another device that has the necessary connection (e.g., the image capture device using a WiFi/cellular connection of a paired mobile device, such as a smartphone, tablet, laptop, to store the image-audio information in one or more storage media). Other storage locations for and storage of the image-audio information are contemplated.

In some implementations, storage of the image-audio information may include sharing/publication of the image-audio information on one or more sharing platforms. Sharing of the image-audio information may be easier (e.g., consume less resources, such as bandwidth, memory, processing) than sharing video content including images (including the image included in the audio-enhanced image content) and audio content because the audio-enhanced image content may be smaller in size than the video content.

While the description herein may be directed to image content, one or more other implementations of the system/method described herein may be configured for other types media content. Other types of media content may include one or more of audio content (e.g., music, podcasts, audio books, and/or other audio content), multimedia presentations, images, slideshows, visual content (one or more images and/or videos), and/or other media content.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 12, and the display 14 are shown to be connected to the interface 13 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be configured to execute one or more components by software; hardware; firmware; some combination of software, hardware, and/or firmware; and/or other mechanisms for configuring processing capabilities on the processor 11.

It should be appreciated that although computer components are illustrated in FIG. 1 as being co-located within a single processing unit, in implementations in which processor 11 comprises multiple processing units, one or more of computer program components may be located remotely from the other computer program components.

While computer program components are described herein as being implemented via processor 11 through machine readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 12 may be provided integrally (i.e., substantially non-removable) with one or more components of the system 10 and/or removable storage that is connectable to one or more components of the system 10 via, for example, a port (e.g., a USB port, a Firewire port, etc.) or a drive (e.g., a disk drive, etc.). The electronic storage 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 12 may be a separate component within the system 10, or the electronic storage 12 may be provided integrally with one or more other components of the system 10 (e.g., the processor 11). Although the electronic storage 12 is shown in FIG. 1 as a single entity, this is for illustrative purposes only. In some implementations, the electronic storage 12 may comprise a plurality of storage units. These storage units may be physically located within the same device, or the electronic storage 12 may represent storage functionality of a plurality of devices operating in coordination.

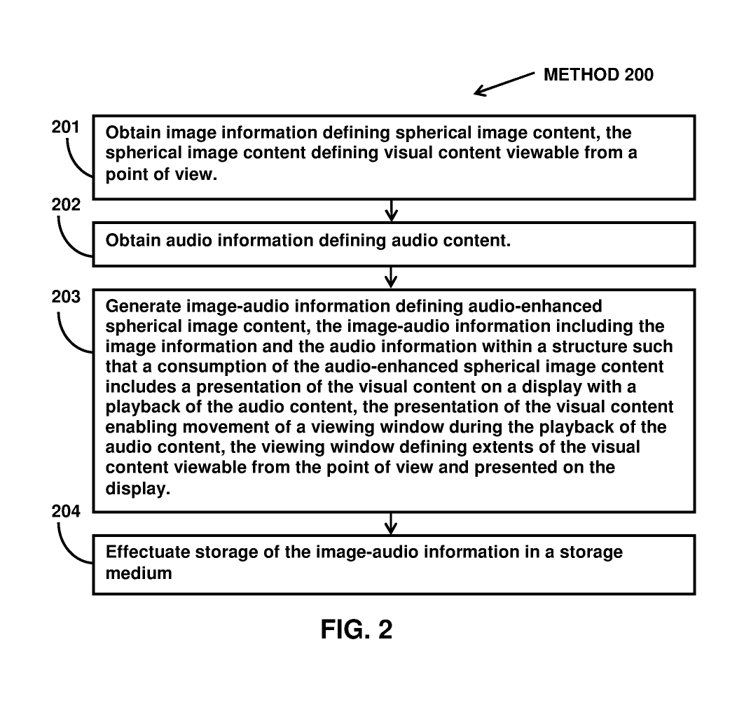

FIG. 2 illustrates method 200 for generating audio-enhanced images. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage mediums. The one or more processing devices may include one or more devices configured through hardware, firmware, and/or software to be specifically designed for execution of one or more of the operation of method 200.

Referring to FIG. 2 and method 200, at operation 201, image information defining spherical image content may be obtained. The spherical image content may define visual content viewable from a point of view. In some implementation, operation 201 may be performed by a processor component the same as or similar to the image information component 102 (Shown in FIG. 1 and described herein).

At operation 202, audio information defining audio content may be obtained. The audio content may have a duration. The audio content may be captured before, during, and/or after capture of the spherical image content. In some implementations, operation 202 may be performed by a processor component the same as or similar to the audio information component 104 (Shown in FIG. 1 and described herein).

At operation 203, image-audio information defining audio-enhanced spherical image content may be generated. The image-audio information may include the image information and the audio information within a structure such that a consumption of the audio-enhanced spherical image content includes a presentation of the visual content on a display with a playback of the audio content. The presentation of the visual content may enable movement of a viewing window during the playback of the audio content. The viewing window may define extents of the visual content viewable from the point of view and presented on the display.. In some implementations, operation 203 may be performed by a processor component the same as or similar to the image-audio information component 106 (Shown in FIG. 1 and described herein).

At operation 204, storage of the image-audio information in a storage medium may be effectuated. In some implementations, operation 204 may be performed by a processor component the same as or similar to the storage component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system that generates an audio-enhanced spherical image, the system comprising:
one or more physical processors configured by machine-readable instructions to:
obtain image information defining a spherical image, the spherical image depicting visual content viewable from a point of view;
obtain audio information defining audio content, the audio content having a duration, the audio content being captured before, during, and after capture of the spherical image;
generate image-audio information defining an audio-enhanced spherical image, the image-audio information including the image information and the audio information within a structure such that a consumption of the audio-enhanced spherical image includes a presentation of the spherical image on a display with a concurrent playback of the duration of the audio content, the presentation of the spherical image enabling movement of a viewing window during the playback of the duration of the audio content, the viewing window defining extents of the spherical image viewable from the point of view and presented on the display; and
effectuate storage of the image-audio information in a storage medium.

2. The system of claim 1, wherein:
the audio content includes spatial sounds;
the audio information characterizes one or more directions of the spatial sounds within the audio content; and
the playback of the audio content changes based on the movement of the viewing window during the playback of the audio content and the one or more directions of the spatial sounds within the audio content.

3. The system of claim 1, wherein the spherical image is captured by an image capture device and the audio content is captured by an audio capture device of the image capture device.

4. (canceled)

5. The system of claim 1, wherein the spherical image corresponds to a midpoint of the duration of audio content.

6. The system of claim 1, wherein the spherical image corresponds to a non-midpoint of the duration of audio content.

7. The system of claim 1, wherein the spherical image is determined prior to a determination of the audio content.

8. The system of claim 1, wherein the audio content is determined prior to a determination of the spherical image.

9. The system of claim 1, wherein the audio content is determined based on user selection, audio analysis, and/or highlight events.

10. A method for generating an audio-enhanced image, the method performed by a computing system including one or more physical processors, the method comprising:
obtaining, by the computing system, image information defining a spherical image, the spherical image depicting visual content viewable from a point of view;
obtaining, by the computing system, audio information defining audio content, the audio content having a duration, the audio content captured before, during, and after capture of the spherical image;
generating, by the computing system, image-audio information defining an audio-enhanced spherical image, the image-audio information including the image information and the audio information within a structure such that a consumption of the audio-enhanced spherical image includes a presentation of the spherical image on a display with a concurrent playback of the duration of the audio content, the presentation of the spherical image enabling movement of a viewing window during the playback of the duration of the audio content, the viewing window defining extents of the spherical image viewable from the point of view and presented on the display; and
effectuating, by the computing system, storage of the image-audio information in a storage medium.

11. The method of claim 10, wherein:
the audio content includes spatial sounds;
the audio information characterizes one or more directions of the spatial sounds within the audio content; and
the playback of the audio content changes based on the movement of the viewing window during the playback of the audio content and the one or more directions of the spatial sounds within the audio content.

12. The method of claim 10, wherein the spherical image is captured by an image capture device and the audio content is captured by an audio capture device of the image capture device.

13. (canceled)

14. The method of claim 10, wherein the spherical image corresponds to a midpoint of the duration of audio content.

15. The method of claim 10, wherein the spherical image corresponds to a non-midpoint of the duration of audio content.

16. The method of claim 10, wherein the spherical image is determined prior to a determination of the audio content.

17. The method of claim 10, wherein the audio content is determined prior to a determination of the spherical image content.

18. The method of claim 10, wherein the audio content is determined based on user selection, audio analysis, and/or highlight events.

19. A system that generates an audio-enhanced spherical image, the system comprising:
one or more physical processors configured by machine-readable instructions to:
obtain image information defining a spherical image, the spherical image depicting visual content viewable from a point of view;
obtain audio information defining audio content, the audio content having a duration, the audio content being captured before, during, and after capture of the spherical image, wherein the audio content includes spatial sounds and the audio information characterizes one or more directions of the spatial sounds within the audio content;
generate image-audio information defining an audio-enhanced spherical image, the image-audio information including the image information and the audio information within a structure such that a consumption of the audio-enhanced spherical image includes a presentation of the spherical image on a display with a playback of the duration of the audio content, the presentation of the spherical image enabling movement of a viewing window during the playback of the duration of the audio content, the viewing window defining extents of the visual content viewable from the point of view and presented on the display, wherein the playback of the audio content changes based on the movement of the viewing window during the playback of the audio content and the one or more directions of the spatial sounds within the audio content; and
effectuate storage of the image-audio information in a storage medium.

20. The system of claim 19, wherein the spherical image is captured by an image capture device and the audio content is captured by an audio capture device of the image capture device.
